(19) United States
(12) Patent Application Publication
(10) Pub. No.: US 2026/0196471 A1
(43) Pub. Date: Jul. 9, 2026

(54) CYLINDRICAL BATTERY CELL WITH REDUCED INTERNAL STRESS

(71) Applicant: Rivian IP Holdings, LLC, Irvine, CA (US)

(72) Inventors: Yumi KIM, San Jose, CA (US); Yunki Baik, San Jose, CA (US); Byoungchul You, Saratoga, CA (US); Soo Kim, Fremont, CA (US)

(21) Appl. No.: 19/303,244

(22) Filed: Aug. 18, 2025

Related U.S. Application Data
(60) Provisional application No. 63/741,607, filed on Jan. 3, 2025.

(51) Int. Cl. H01M 4/131; H01M 4/02; H01M 10/0525; H01M 10/0587; H01M 50/107; H01M 50/119; H01M 50/133

(52) U.S. Cl. CPC H01M 4/131; H01M 10/0525; H01M 10/0587; H01M 50/107; H01M 50/119; H01M 50/133; H01M 2004/021; H01M 2004/028; H01M 2220/20

(57) ABSTRACT

A positive electrode having lower loading of cathode active material at an end of the electrode when combined with a negative electrode and separator therebetween can reduce stress when in a rolled configuration. In particular, a positive electrode can include a cathode active material loaded on a first major surface of a current collector along a length direction of the current collector in which the cathode active material has an average areal loading in a zone at a distal end that is less than the average areal loading of the cathode active material at a proximal zone on the first major surface of the current collector along the length direction of the current collector.

### CROSS REFERENCE TO RELATED APPLICATION

This application claims the benefit of priority to U.S. Provisional Patent Application No. 63/741,607, entitled “CYLINDRICAL BATTERY CELL WITH REDUCED INTERNAL STRESS”, filed on Jan. 3, 2025, the disclosure of which is hereby incorporated herein in its entirety.

### INTRODUCTION

Batteries are often used as a source of power, including as a source of power for electric vehicles that include wheels that are driven by an electric motor that receives power from the battery.

Aspects of the subject technology can help to improve the reliability and/or energy density of rechargeable batteries employed with electric vehicles, which can help to mitigate climate change by reducing greenhouse gas emissions.

### SUMMARY

The present description generally relates to a positive electrode having an average areal loading of cathode active material at an end of a current collector along a length of the current collector. Such a positive electrode can be combined with a separator and negative electrode and assembled in a rolled configuration for a cylindrical cell. The lower loading of cathode active material can be located at the core of the jelly roll which can advantageously result in a lower thickness of solid-electrolyte interphase (SEI) formed on the anode during cell cycling and consequently lower stress.

In an implementation, a positive electrode can include a cathode active material loaded on a first major surface of a current collector along a length direction of the current collector in which the cathode active material has a first average loading in a first zone (Z1), a second average loading in a second zone (Z2), and a third average loading in a third zone (Z3) on the first major surface of the current collector along the length direction of the current collector. In some aspects, the second average loading of cathode material in the second zone is less than the third average loading of cathode material in the third zone. The loading is configured such that when the positive electrode is in a rolled configuration along the length direction, the first zone and second zone are located at an interior, e.g., around the center of the rolled configuration, and the third zone is located radially away from the interior of the rolled configuration.

The positive electrode can further include cathode active material loaded on a second major opposing surface of the current collector along the length direction of the current collector in which the cathode active material has a fourth average loading in a fourth zone, a fifth average loading in a fifth zone, and a sixth average loading in a sixth zone on the second major surface of the current collector along the length direction of the current collector. In some aspects, the fifth average loading of cathode material in the fifth zone is less than the sixth average loading of cathode material in the sixth zone. The loading can be configured such that when the positive electrode is in a rolled configuration along the length direction, the fourth zone and fifth zone are located at the interior and the sixth zone is located radially away from the interior of the rolled configuration.

In accordance with one or more implementations, a cylindrical battery cell can include a positive electrode of the present disclosure; a negative electrode; a separator therebetween which in a rolled configuration in a cylindrical container. Further an electrolyte can be included in the container. In some aspects, the cathode active material can include layered, high nickel lithium transition metal oxides having greater than about 80% nickel.

Other implementations of the present disclosure include a method of charging and discharging a cylindrical battery cell that includes a positive electrode of the present disclosure. Such a battery cell can be configured to have the positive electrode; a negative electrode, and a separator therebetween; and an electrolyte.

In one or more implementations, a cylindrical battery cell having a positive electrode as described herein may be included in a building and/or moveable apparatus, e.g., a vehicle. For example, such a battery cell may be configured to power a component or system of a building and/or a vehicle.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack in accordance with one or more implementations of the present disclosure.

FIG. 1C illustrates a schematic perspective view of a building having a battery pack in accordance with one or more implementations of the present disclosure.

FIG. 2A illustrates a schematic perspective view of a battery pack in accordance with one or more implementations of the present disclosure.

FIG. 2B illustrates schematic perspective views of various battery modules that may be included in a battery pack in accordance with one or more implementations of the present disclosure.

FIG. 2C illustrates a cross-sectional end view of a battery cell in accordance with one or more implementations of the present disclosure.

FIG. 2D illustrates a cross-sectional perspective view of a cylindrical battery cell in accordance with one or more implementations of the present disclosure.

FIG. 3A illustrates a positive electrode with varying loading of cathode active material along a length of a current collector in accordance with implementations of the present disclosure.

FIG. 3B is a cross sectional view of FIG. 3A.

FIG. 4 illustrates a cross sectional view of another positive electrode with varying loading of cathode active material along a length of a current collector in accordance with implementations of the present disclosure.

FIGS. 5A and 5B illustrate sectional views of a model cylindrical jelly roll and levels of stress at the core radiating outward of the jelly roll.

FIG. 6 illustrates graphs showing relative average loading of cathode active material by mass along a current collector versus electrode length.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As discussed in further detail hereinafter, a battery cell including a positive electrode having lower loading of cathode active material at an end of the electrode of the present disclosure can be used to store and discharge electrical energy. A battery cell of the present disclosure can be used alone or multiple battery cells can be assembled or packaged together in the same housing, frame, or casing to form a battery subassembly, module and/or battery pack. Further, multiple battery subassemblies or modules can be assembled or packaged together to form a battery pack. The battery cells of a battery subassembly, module and/or pack can be electrically connected to generate a desired voltage output for the battery subassembly, module and/or pack. The battery subassembly, module and/or pack in turn can be electrically connected to a power-consuming component, such as a vehicle and/or an electrical system of a building.

### Vehicles, Battery Packs, Cells

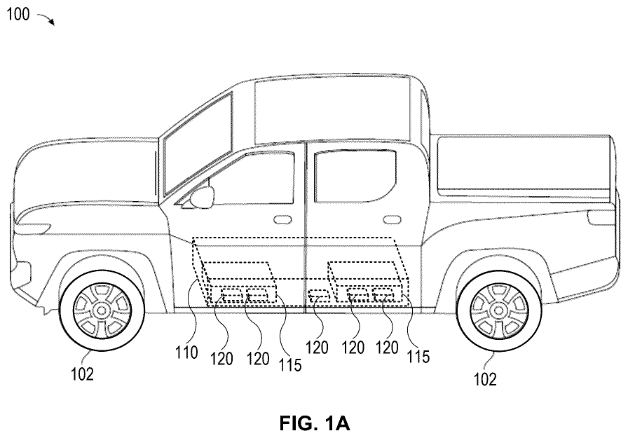

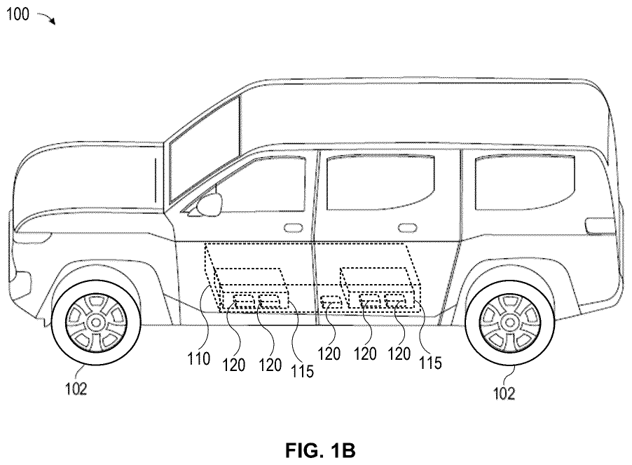

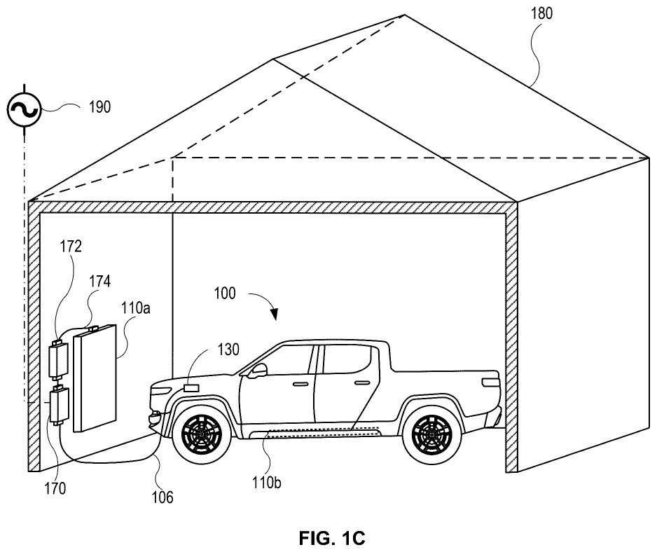

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. For example, the building 180 may be a residential building, a commercial building, or any other building. As shown, in one or more implementations, a battery pack 110 may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

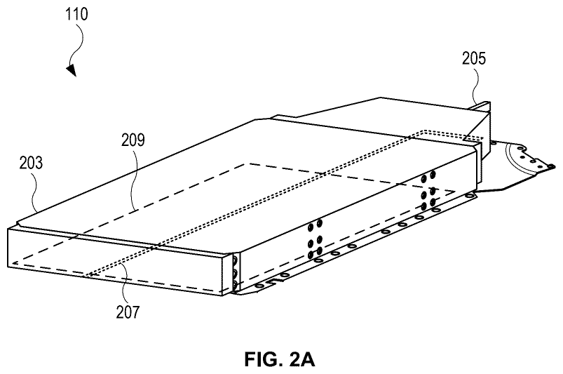

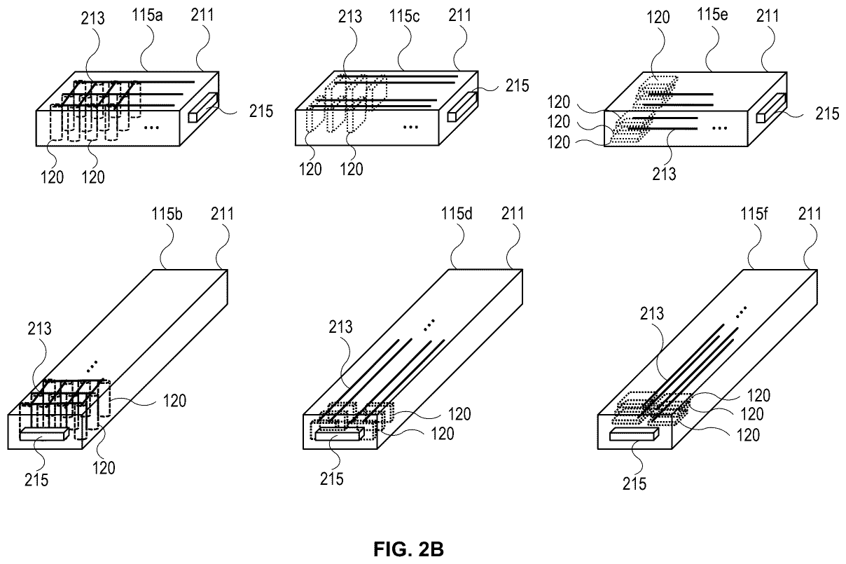

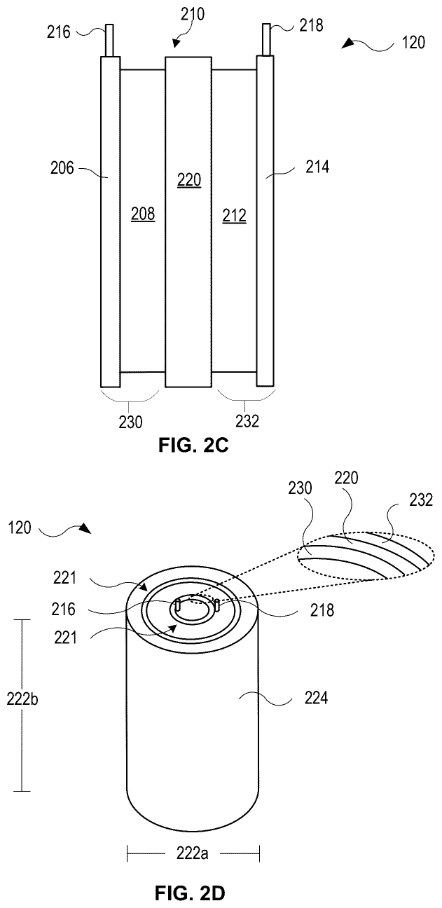

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongated shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown in FIG. 2C, a battery cell 120 may include a negative electrode 230 and a positive electrode 232, which are separated by separator 220. As shown, the negative electrode includes an anode active material 208and electrically coupled to a first current collector 206 (e.g., a metal layer such as a layer of copper foil or other metal foil). As further shown, the positive electrode includes a cathode active material 212 on and electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the battery cell can include a liquid electrolyte 210.

In one or more implementations, the battery cell 120 may be implemented as a lithium ion battery cell in which the anode active material 208 is formed from a carbonaceous material (e.g., graphite or silicon-carbon). In these implementations, lithium ions can move from the anode active material 208, through the separator 220, to the cathode active material 212 during discharge of the battery cell 120 (e.g., and through the electrolyte 210). For example, the anode active material 208 may be formed from a graphite material that is coated on a copper foil corresponding to the first current collector 206. In these lithium ion implementations, the cathode active material 212 may be formed from one or more metal oxides (e.g., a lithium cobalt oxide, a lithium manganese oxide, a lithium nickel metal oxide such as a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode active material 208 and the cathode active material 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the negative electrode 230, the separator 220, and the positive electrode 232 of FIG. 2C can be packaged into a battery cell housing having any of various sizes, and/or formed from any of various suitable materials. For example, battery cells 120 can have a cylindrical outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimensions. In some aspects, the dimensions of a battery cell can have a diameter of about 20 mm to about 65 mm and a length, or height (222b dimension) of from about 60 mm to about 120 mm. For example, the dimension 222a and the dimension 222b may be 46 mm or greater and 80 mm or greater, respectively. The cell housing further can be made of suitable materials such as a metal or metal alloy, e.g., steel, and can have a thickness to withstand pressure and temperatures to operate the battery cell such as a sidewall cross sectional thickness of from about 0.3 mm to about 0.5 mm.

As shown in the enlarged view of FIG. 2D, the negative electrode 230, the separator 220, and the positive electrode 232 may be rolled into one or more substantially cylindrical windings 221. As shown, one or more windings 221 of the negative electrode 230, the separator 220, and the positive electrode 232 may be disposed within the cell housing 224. Additionally, the battery cell 120 in the cylindrical cell implementation of FIG. 2D includes a terminal 216 and a terminal 218. The terminal 218 may include a first polarity terminal, such as a positive terminal, which is coupled to the positive electrode 232. The terminal 216 may include a second polarity terminal, such as a negative terminal, which is coupled to the negative electrode 230. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

In the examples of FIGS. 2C and 2D, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or different sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 224 of the battery cell 120 can be disposed in the battery module 115, the battery pack 110, or installed in any of the vehicle 100, the building 180, or any other electrically powered component or device.

### Positive Electrode

As discussed above, a battery cell (e.g., battery cell 120) including a positive electrode of the present disclosure can be used to store and discharge electrical energy and implemented in a building and/or movable apparatus. The positive electrode of the present disclosure can be used in lithium ion battery cells and is particularly useful in cylindrical housings.

To improve cell energy density and efficiency, some manufactures are increasing the size of cylindrical battery cells used in electric vehicles. However, as the size of the cell increases, the formation of a solid electrolyte interphase (SEI) on the anode electrode during cell cycling thickens causing internal stress that appears to be greatest at the interior, e.g., around the center, of the cell. A positive electrode with a stepped loading of the cathode active material of the present disclosure can mitigate such stress.

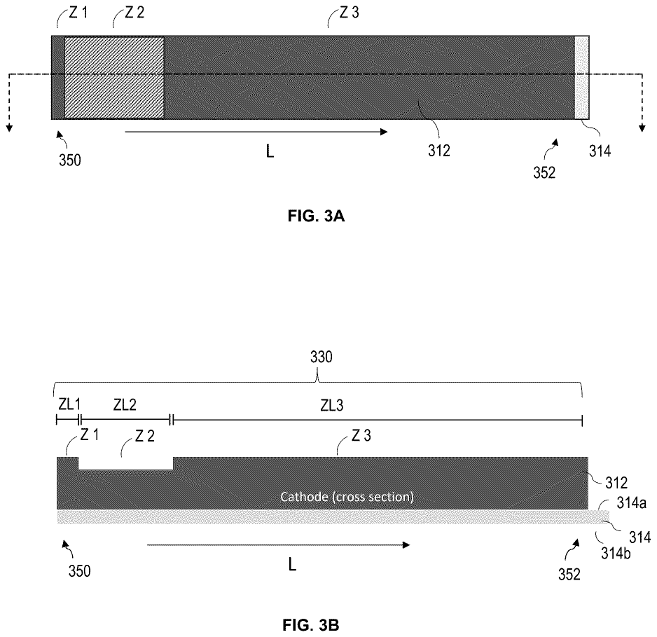

FIG. 3A illustrates an example implementation of a positive electrode of the present disclosure and FIG. 3B. illustrates a cross sectional view of the electrode. As shown, positive electrode (300) includes a cathode active material (312) loaded on a first major surface (314a) of a current collector (314) along a length direction (L) of the current collector. In this example, the loading of the cathode active material 312 on the current collector (314) does not completely cover the current collector such that a portion of the current collector is free of cathode active material at proximal end 352. As further shown, loading of the cathode active material is not the same along the length direction of the electrode. The cathode active material has a first average loading in a first zone (Z1), a second average loading in a second zone (Z2), and a third average loading in a third zone (Z3) on the first major surface (312a) of the current collector (314) along the length direction (L) of the current collector. Each zone can have a length such that the first zone (Z1) has a first length (ZL1), the second zone (Z2) has a second length (ZL2) and the third zone (Z3) has a third length (ZL3). The positive electrode also has a width which can approximate the height of the battery cell. In an aspect, the positive electrode has a width of from about 60 mm to about 120 mm. The average loading can be determined as an average areal loading in units of mass per area.

Advantageously, the second average loading of cathode material in the second zone (Z2), which is at a distal end (350) of the electrode, is less than the third average loading of cathode material in the third zone Z3. For example, the second average loading in the second zone can be from about 0.5% to about 15% by mass/area less, e.g., from about 1% to about 10% by mass less, than the third average loading in the third zone. In some aspects, the first average loading of cathode material in the first zone is approximately the same as the third average loading of cathode material in the third zone.

Further, and in an independent aspect, the second zone has a length along the length direction of the current collector (L) which can be from 1% to 20%, e.g., from about 5% to about 15%, of a total length of the current collector having cathode active material loaded on the first major surface, i.e., the sum of ZL1, ZL2 and ZL3 shown by element 330.

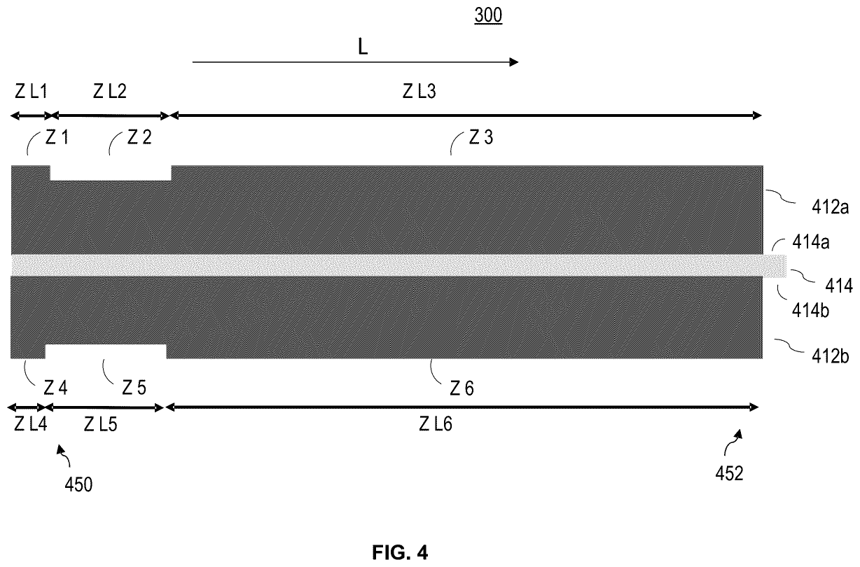

FIG. 4 illustrates a positive electrode of the present disclosure in which opposing surfaces of a current collector are step loaded with cathode active material. In this example, cathode active material (412a) is loaded on a first major surface (414a) of current collector (414) and cathode active material (412b) is loaded on a second major opposing surface (414b) of the current collector (414) along the length direction (L) of the current collector.

In this example, the loading of the cathode active material 412 on the current collector (414) does not completely cover the current collector such that a portion of the current collector is free of cathode active material at proximal end 452. As further shown, loading of the cathode active material is not the same along the length direction of the electrode. The cathode active material has a first, second, and third average loading in the first, second and third zones (Z1, Z2, Z3), respectively, on the first major surface (412a) of the current collector (414) along the length direction (L) of the current collector. For this example, the cathode active material is loaded on a second major opposing surface (412b) of the current collector (414) along the length direction (L) of the current collector in which the cathode active material has a fourth average loading in a fourth zone (Z4), a fifth average loading in a fifth zone (Z5), and a sixth average loading in a sixth zone (Z6) on the second major surface of the current collector along the length direction of the current collector. Each zone can have a length such that the first zone (Z1) has a first length (ZL1), the second zone (Z2) has a second length (ZL2), the third zone (Z3) has a third length (ZL3), the fourth zone (Z4) has a fourth length (ZL4), the fifth zone (Z5) has a fifth length (ZL5), the sixth zone (Z6) has a sixth length (ZL6). The average loading can be determined as an average areal loading in units of mass per area.

Advantageously, the second average loading of cathode material in the second zone (Z2), which is at a distal end (450) of the electrode, is less than the third average loading of cathode material in the third zone Z3. Additionally, for this example, the fifth average loading of cathode material in the fifth zone (Z5), which is at a distal end (450) of the electrode, is less than the sixth average loading of cathode material in the sixth zone (Z6). Although not needed to practice the subject technology, for manufacturing convenience, the second and fifth average loading of cathode material are approximately the same and the average loading of cathode material in the third zone and the sixth zone are approximately the same. In addition, in some aspects, the first and fourth average loading of cathode material in the first and fourth zones are approximately the same as the third and sixth average loading of cathode material.

In an implementation, the second average loading in the second zone or the fifth average loading in the fifth zone can be from about 0.5% to about 15% by mass/area less, e.g., from about 1% to about 10% by mass/area less, than the third or sixth, respectively, average loading in the third or sixth zone.

Further, and in an independent aspect, the fifth zone has a length along the length direction of the current collector (L) which can be from 1% to 20%, e.g., from about 5% to about 15%, of a total length of the current collector having cathode active material loaded on the second major opposing surface, i.e., the sum of ZL4, ZL5 and ZL6 provides the total length the current collector has cathode active material on the second major opposing surface.

The positive electrode of the present disclosure can be assembled with a separator and negative electrode and rolled to fit in a cylindrical container. Advantageously, when the positive electrode is in a rolled configuration along the length direction (L), the first zone (Z1) and second zone (Z2) (and optionally the fourth and fifth zones) are located at an interior and the third zone (and optionally sixth zone) is located radially away from the interior of the rolled configuration. In this way, the interior or core of the jelly roll has less cathode active material resulting in a lower thickness of solid electrolyte interphase (SEI) formed on the anode during cell cycling and consequently lower stress.

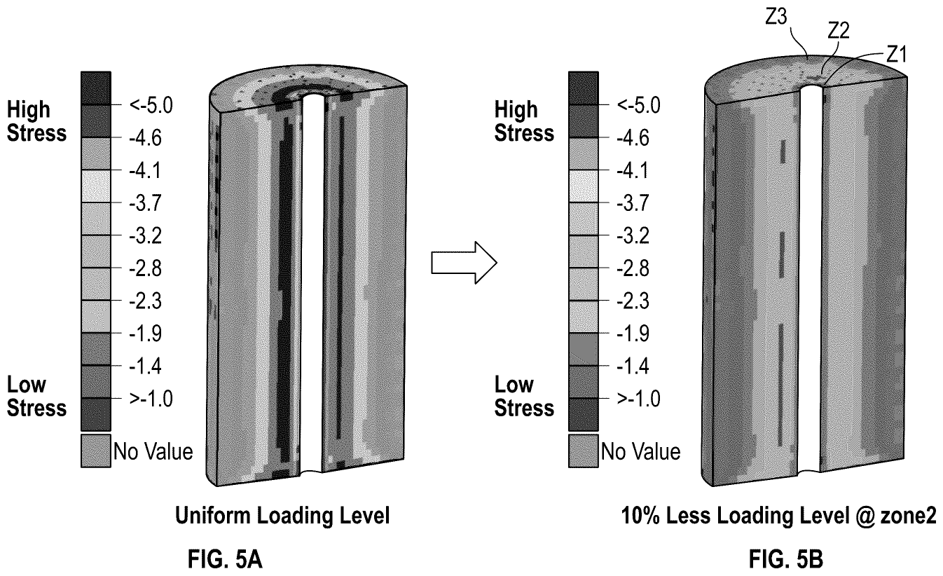

FIGS. 5A and 5B illustrate sectional views of a model cylindrical jelly roll and levels of stress at the core radiating outward of the jelly roll. In particular, FIG. 5A shows the stress level associated with a cylindrical jelly roll having a positive electrode, separator and negative electrode with uniform active materials on the electrodes. FIG. 5B cells shows the stress level associated with a cylindrical jelly roll having a positive electrode, separator and negative electrode in which a positive electrode configured similar to that set forth in FIG. 3A has an average loading of cathode active material in a second zone that is about 10% by mass/are less than the average loading of cathode active material in a third zone. For this model, the positive electrode having less average loading of cathode active material is in a rolled configuration along the length direction (L), the first zone (Z1) and second zone (Z2) are located at an interior, or core or center, and the third zone (Z3) is located radially away from the interior of the rolled configuration (FIG. 5B). As shown by the model, when the positive electrode having less average loading of cathode active material in zone 2 shows less stress in the interior or core at zones 1 and 2 as compared to the jelly roll with a positive electrode having uniform loading (compare FIG. 5A to 5B). The simulation was conducted using nonlinear ABAQUS solver, which can reflect the mechanical properties of the parts and the electrode modulus. The modeling of mechanical parts and the jellyroll (JR) structure is based on CT scan images.

In some implementations, a positive electrode of the present disclosure can be included in a jelly roll and the jelly roll housed in a cylindrical container. The cylindrical container can comprise a metal or alloy such as aluminum, steel, steel use stainless(SUS), Ni plated steel, etc. Further, a side wall cross-sectional thickness can range from about 0.2 mm to about 0.8 mm, e.g., from about 0.3 mm to about 0.5 mm. For example, the cylindrical battery cell can have dimensions of a 46XX cylindrical battery cell (e.g., a 4695 cylindrical cell).

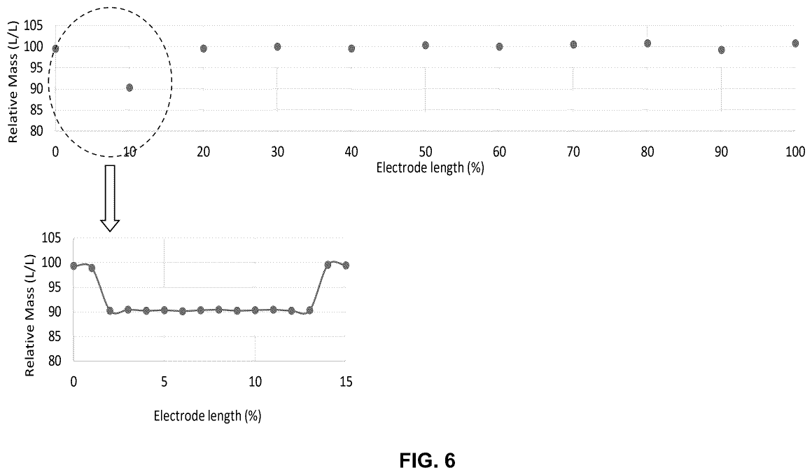

FIG. 6 illustrates graphs showing relative average loading of cathode active material by mass along a current collector versus electrode length. As shown, a second average loading in a second zone is about 10% by mass less than a first and third zone and the length of the second zone is about 12% the total length of the electrode. This loading gap and the step length can be varied upon the cell energy density and cell size, but in case of 4695 cell, in order to release the stress concentration near the core area, this step design at cathode valid ranges.

A positive electrode having lower loading of cathode active material at an end of the electrode can include a variety of cathode active materials. Such cathode active materials can comprise, without limitation: one or more lithium metal oxides, e.g., a lithium cobalt oxide, a lithium manganese oxide, a lithium nickel manganese cobalt oxide (NMC), lithium nickel cobalt aluminum oxide (NCA), over-lithiated oxides (OLO), which includes an excess stoichiometric mole amount of lithium in a lithium metal oxide, etc., and/or a specific type of OLO, lithium-manganese-rich (LMR) compound, and/or a high-entropy lithium oxide cathode active material, and/or a lithium metal phosphate, such as a lithium iron phosphate, lithium manganese phosphate, lithium manganese iron phosphate, etc., lithium spinel, or any combinations thereof. In some aspects, the cathode active material can include layered, high nickel lithium transition metal oxides having greater than about 60%, 80% and even greater than 90% nickel. For example, the cathode active material can include Ni-rich lithium transition metal oxides, e.g., Li[Ni_{1-x-y}CoₓAl_{y}]O₂ (NCA) or Li[Ni_{1-x-y}CoₓMn_{y}]O₂ (NCM), in which the amount of Nickel is from about 60% to about 98%. Such Ni-rich lithium transition metal oxides can also include manganese such as Li[Ni_{1-x-y-z}CoₓMn_{y}Al_{z}]O₂ (NCMA), e.g., Li[Ni_{0.89}Co_{0.05}Mn_{0.05}Al_{0.01}]O₂. In some aspects, the OLO active material has a formula of: Li_{1+y}M_{1-y}O₂, where 0<y≤0.4 and M is a transition metal such as Ni and/or Mn, which may be doped with Al. In other aspects, LMR compound has a formula of: Li_{1+y}(M_{1-y})O₂, which includes a high portion of manganese and lithium, where 0<y≤0.25 and M is a transition metal including Mn, which can also include Ni, and can be doped with cobalt. In still further aspects, either the OLO active material and/or the LMR compound has less than about 7 wt % cobalt, such as less than 3 wt %, or less than 2 wt % cobalt.

Electrodes including active materials of the present disclosure can be fabricated by initially preparing a slurry of the active materials in a liquid medium with optionally other ingredients such as a binder, conductive carbon, etc. The slurries can then be used to coat the first and/or opposing major surfaces of current collectors followed by drying. The areal densities of the coatings can be determined based on a calculation of the dry weights of the active materials with optional additives over the areas coated. This step electrode can be achieved by controlling the coating gap from the coater blade zone by zone. The height of the coater blade or gap can be formed automatically according to the desired thickness of the coating. This height determines the gap between the blade and a current collector foil, which in turn controls the thickness of the coating layer.

For example, an areal density (e.g., area density) of each coating on the first and/or second opposing major surface of the current collector can be at or above 15 mg/cm², e.g., about 17 mg/cm², or higher. However, the areal density is typically no more than about 30 mg/cm² such as in a range of form about 15 mg/cm² to about 28 mg/cm².

Conductive carbon that can be included with the cathode active material include carbon atoms being sp² hybridized, sp³ hybridized, or combinations thereof. The ratio between sp² and sp³ type carbons may be determined by preparation methods including choice of carbon precursor materials, heat treatment conditions, etc. Illustrative conductive carbon materials include, without limitation: graphite, a graphene based conductive carbon, carbon black, Super P carbon black material, Ketjen Black, Acetylene Black, carbon nanotubes, such as single-wall carbon nanotubes (SWCNT), multi-wall carbon nanotubes (MWCNT), carbon nanofiber, graphene, or two or more combinations thereof. Useful binders for forming the electrodes include, for example, polyvinylidenefluoride (PVdF), polyvinylpyrrolidone (PVP), styrene-butadiene or styrene-butadiene rubber (SBR), polytetrafluoroethylene (PTFE), carboxymethylcellulose (CMC) or combinations thereof. The current collector can include a metal, such as aluminum, copper, nickel, titanium, stainless steel, or a metal alloy, or a carbonaceous material, or a combination thereof. The current collector material may be in the form of a foil, such as a metal foil and may be coated with a conductive carbon, such as carbon-coated aluminum foil, carbon-coated copper foil, or other carbon-coated foil material.

In addition to a positive electrode of the present disclosure, a cylindrical battery cell can further include a separator and electrolyte and a negative electrode. The battery cell can further include a positive and a negative terminal, which may be used to electrically connect a load or charger to the battery cell.

Useful separators that may be included in a battery cell of the present disclosure may comprise, without limitation: a polymer such as polyethylene, polypropylene, polyolefin, and/or polyamide, a ceramic, glass, or other insulating materials, or any combination thereof.

Useful electrolytes can include, without limitation, a salt dissolved in a solvent medium. A wide variety of solvent media may be included with liquid electrolyte of battery cells of the present disclosure such as carbonates, ethers and acetates, for example. In one aspect of the present disclosure, the electrolyte includes one or more carbonate solvents such as dimethyl carbonate (DMC), diethyl carbonate (DEC), and ethyl methyl carbonate (EMC), ethylene carbonate (EC), propylene carbonate (PC), vinylene carbonate (VC), fluoroethylene carbonate (FEC), etc. or mixtures thereof. For lithium ion battery cells, a variety of lithium salts may be added to the electrolyte such as lithium hexafluorophosphate (LiPF₆) lithium tetrafluoroborate (LiBF₄), lithium perchlorate (LiClO₄), lithium hexafluoroarsenate (LiAsF₆), lithium triflate (LiSO₃CF₃), etc., or mixtures thereof.

Useful negative electrode that can be included in a battery cell of the present disclosure can include anode active materials composed of, without limitation: graphitic carbon (e.g., ordered or disordered carbon with sp² hybridization, artificial or natural graphite, or blends thereof), lithium metal, lithium alloys such as Li—Mg, Li—Al, Li—Ag alloys, a metal oxide, e.g., lithium titanate, silicon, a silicon-based material (e.g., silicon-based carbon composite, oxide, carbide, a pre-lithiated silicon material), etc. or a combination of any two or more thereof.

In some aspects, negative electrode that can be included in a battery cell in accordance with the present disclosure include an anode active material that may be formed in situ on a current collector. For example, an electrode can include a current collector (e.g., a metal foil such as a copper foil or carbon foil) with an in situ-formed anode active material (e.g., Li metal) on a surface of the current collector facing a separator. In such examples, a battery cell may be configured to lack an anode active material in an uncharged state.

Aspects of the subject technology can help improve the serviceability of electrical power supplies, such as batteries and/or battery packs. This can help facilitate the functioning of and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A positive electrode comprising:
a cathode active material loaded on a first major surface of a current collector along a length direction of the current collector in which the cathode active material has a first average loading in a first zone, a second average loading in a second zone, and a third average loading in a third zone on the first major surface of the current collector along the length direction of the current collector;
wherein the second average loading of cathode material in the second zone is less than the third average loading of the cathode material in the third zone; and
wherein, when the positive electrode is in a rolled configuration along the length direction, the first zone and second zone are located at an interior and the third zone is located radially away from the interior of the rolled configuration.

2. The positive electrode of claim 1, further comprising the cathode active material loaded on a second major opposing surface of the current collector along the length direction of the current collector in which the cathode active material has a fourth average loading in a fourth zone, a fifth average loading in a fifth zone, and a sixth average loading in a sixth zone on the second major opposing surface of the current collector along the length direction of the current collector;
wherein the fifth average loading of cathode material in the fifth zone is less than the sixth average loading of cathode material in the sixth zone; and
wherein the fourth zone and fifth zone are located at the interior and the sixth zone is located radially away from the interior of the rolled configuration.

3. The positive electrode of claim 2, wherein the first average loading of cathode material in the first zone is approximately the same as the third average loading of cathode material in the third zone; and wherein the fourth average loading of cathode material in the fourth zone is approximately the same as the sixth average loading of cathode material in the sixth zone.

4. The positive electrode of claim 1, wherein the second average loading in the second zone is from about 0.5% to about 15% by mass less than the third average loading in the third zone.

5. The positive electrode of claim 1, wherein the second average loading in the second zone is from about 1% to about 10% by mass less than the third average loading in the third zone.

6. The positive electrode of claim 1, wherein the second zone has a length along the length direction of the current collector which is from 1% to 20% of a total length of the current collector having cathode active material loaded on the first major surface.

7. The positive electrode of claim 1, wherein the second zone has a length along the length direction of the current collector which is from 5% to 15% of a total length of the current collector having cathode active material loaded on the first major surface.

8. The positive electrode of claim 1, wherein the first average loading of cathode material in the first zone is approximately the same as the third average loading of cathode material in the third zone; wherein the second average loading in the second zone is from about 0.5% to about 15% by mass less than the third average loading in the third zone; and wherein the second zone has a length along the length direction of the current collector which is from 1% to 20% of a total length of the current collector having cathode active material loaded on the first major surface.

9. The positive electrode of claim 1, wherein the positive electrode has a width of from about 60 mm to about 120 mm.

10. The positive electrode of claim 1, wherein the cathode active material comprises layered, high nickel lithium transition metal oxides having greater than about 80% nickel.

11. The positive electrode of claim 1, wherein the third average loading of cathode material in the third zone is from about 15 mg/cm² to about 28 mg/cm².

12. A cylindrical battery cell, comprising:
a positive electrode; a negative electrode; a separator therebetween which are in a rolled configuration in a cylindrical container; and an electrolyte in the cylindrical container;
wherein the positive electrode comprises a cathode active material loaded on a first major surface of a current collector along a length direction of the current collector in which the cathode active material has a first average loading in a first zone, a second average loading in a second zone, and a third average loading in a third zone on the first major surface of the current collector along the length direction of the current collector;
wherein the second average loading of cathode material in the second zone is less than the third average loading of cathode material in the third zone; and
wherein the first zone and second zone are located at an interior and the third zone is located radially away from the interior of the rolled configuration.

13. The cylindrical battery cell of claim 12, wherein the cylindrical container is composed of steel.

14. The cylindrical battery cell of claim 12, wherein the cylindrical container has a thickness of from about 0.3 mm to about 0.5 mm.

15. The cylindrical battery cell of claim 12, wherein the positive electrode further comprises the cathode active material loaded on a second major opposing surface of the current collector along the length direction of the current collector in which the cathode active material has a fourth average loading in a fourth zone, a fifth average loading in a fifth zone, and a sixth average loading in a sixth zone on the second major opposing surface of the current collector along the length direction of the current collector;
wherein the fifth average loading of cathode material in the fifth zone is less than the sixth average loading of cathode material in the sixth zone; and
wherein the fourth zone and fifth zone are located at the interior and the sixth zone is located radially away from the interior of the rolled configuration.

16. The cylindrical battery cell of claim 15, wherein the first average loading of cathode material in the first zone is approximately the same as the third average loading of cathode material in the third zone; and wherein the fourth average loading of cathode material in the fourth zone is approximately the same as the sixth average loading of cathode material in the sixth zone.

17. The cylindrical battery cell of claim 12, wherein the second zone has a length along the length direction of the current collector which is from 1% to 20% of a total length of the current collector having cathode active material loaded on the first major surface.

18. The cylindrical battery cell of claim 12, wherein the first average loading of cathode material in the first zone is approximately the same as the third average loading of cathode material in the third zone; wherein the second average loading in the second zone is from about 0.5% to about 15% by mass less than the third average loading in the third zone; and wherein the second zone has a length along the length direction of the current collector which is from 1% to 20% of a total length of the current collector having cathode active material loaded on the first major surface.

19. The cylindrical battery cell of claim 12, wherein the cathode active material comprises layered, high nickel lithium transition metal oxides having greater than about 80% nickel.

20. A vehicle comprising the cylindrical battery cell of claim 12.
